(19) United States
(12) Patent Application Publication
(10) Pub. No.: US 2017/0287266 A9
(43) Pub. Date: Oct. 5, 2017

(54) Systems and Methods for Generating Measurable Units for Use Within a Virtual Environment by Interacting With Rewarded Units

(71) Applicant: Machine Zone, Inc., Palo Alto, CA (US)

(72) Inventors: Gabriel Leydon, Redwood City, CA (US); Halbert Nakagawa, San Jose, CA (US)

(21) Appl. No.: 15/265,397

(22) Filed: Sep. 14, 2016

Related U.S. Application Data
(63) Continuation of application No. 13/471,129, filed on May 14, 2012, now abandoned.
(60) Provisional application No. 61/486,208, filed on May 13, 2011.

(51) Int. Cl. G07F 17/32; G07F 17/34

(52) U.S. Cl. CPC G07F 17/3225; G07F 17/3255; G07F 17/34; G07F 17/329; G07F 17/3293

(57) ABSTRACT

Systems and methods for a support game are disclosed. In some embodiments, a method comprises enabling a first player to play a first main game with a first economy, receiving a request to engage in a support game, displaying a first instance of the support game in response to the request, providing a first virtual good to the first player, the first virtual good being usable in the first game, enabling a second player to play a second main game with a second economy, receiving a request to engage in the support game, displaying a second instance of the support game in response to the request, and providing a second virtual good to the second player in response to the second player interacting with the second instance of the support game, the second virtual good being usable in the second game.

### CROSS-REFERENCE TO RELATED APPLICATIONS

This application claims priority from U.S. Provisional Application Ser. No. 61/486,208 filed May 13, 2011, entitled “Systems and Methods for a Support Game” which is hereby incorporated by reference.

### FIELD OF THE INVENTION

The present invention(s) generally relate to games. More particularly, the invention(s) relate to systems and methods for a support game that supports a main game.

### DESCRIPTION OF RELATED ART

The advent of new and increasingly powerful mobile devices and the ubiquity of the computer in the home have given rise to new forms of entertainment. As a result, gaming has become an increasingly common revenue-generating activity.

Players are engaging with games in new ways and are seeking experiences that were not available a few short years ago. Social gaming is one example of ways in which players wish to be entertained but also to interact with friends and family. Many players are no longer interested in paying for a long game that comes in a box. Many people desire access to games with little or no cost to entry which allows players to play wherever they are (e.g., with mobile devices).

In spite of these changes, many businesses find opportunities to generate revenue while offering games without an initial cost. Game providers often provide virtual stores or allow players to make purchases of virtual items or goods that may be used within the game. Although such purchases are not required, these virtual items and goods may assist the player to achieve objectives, make game play more enjoyable, and/or allow a player to craft a unique experience within the game that they may share with others.

Unfortunately, providing a scalable game is expensive and many players may take advantage of the free game without making any purchases. As a result, many game providers have difficulty in affording new games or attracting players who are willing to make purchases. Game providers need new ways to attract players who are willing to provide revenue and encourage players to undertake revenue-generating activities.

### SUMMARY OF THE INVENTION

Systems and methods for a support game are disclosed. In some embodiments, a method comprises enabling a first player to play a first main game with a first economy, receiving a request by the first player to engage in a support game, displaying a first instance of the support game to the first player in response to the request, providing a first virtual good to the first player in response to the first player interacting with the first instance of the support game, the first virtual good being usable in the first game, enabling a second player to play a second main game with a second economy, receiving a request by the second player to engage in the support game, displaying a second instance of the support game to the second player in response to the request, and providing a second virtual good to the second player in response to the second player interacting with the second instance of the support game, the second virtual good being usable in the second game.

In some embodiments, the first virtual good is a virtual currency, points, or credit that may be used with the first economy. The second virtual good may also be a virtual currency, points, or credit that may be used with the second economy.

The first virtual good may be a virtual item that may be used in the first main game. The method may further comprise enabling the first and second players to play a game of chance in the first and second instances of the support game. Providing the first and second virtual goods to the first and second players, respectively, may comprise the first and second players winning the first and second virtual goods in the game of chance.

The support game may be a virtual casino configured to allow players to play games of chance. The provider of the first main game may configure the first instance of the support game to identify the first virtual good. The provider of the first main game may further determine a probability that the first virtual good will be provided in the first instance of the support game.

The method may further comprise providing a ticket to the first player which is required to play within the first support game. In some embodiments, the method comprises providing a virtual item in exchange for the first virtual good in a virtual store, the virtual item being usable in the first main game.

In various embodiments, an exemplary system comprises a processor, a first main game module, a second main game module, a support game request module, a display module, and a support game virtual good module. The first main game module may be configured to enable a first player to play a first main game with a first economy. The second main game module may be configured to enable a second player to play a second main game with a second economy. The support game request module may be configured to receive a request by the first player to engage in a support game and to receive a request by the second player to engage in the support game. The display module may be configured to provide a display of a first instance of the support game to the first player in response to the request and to provide a display of the second instance of the support game to the second player in response to the request. The support game virtual good module may be configured to provide a first virtual good to the first player in response to the first player interacting with the first instance of the support game, the first virtual good being usable in the first game, and provide a second virtual good to the second player in response to the second player interacting with the second instance of the support game, the second virtual good being usable in the second game.

An exemplary non-transitory computer readable media may comprise executable instructions. The executable instructions may be executable by a processor for performing a method. The method may comprise enabling a first player to play a first main game with a first economy, receiving a request by the first player to engage in a support game, displaying a first instance of the support game to the first player in response to the request, providing a first virtual good to the first player in response to the first player interacting with the first instance of the support game, the first virtual good being usable in the first game, enabling a second player to play a second main game with a second economy, receiving a request by the second player to engage in the support game, displaying a second instance of the support game to the second player in response to the request, and providing a second virtual good to the second player in response to the second player interacting with the second instance of the support game, the second virtual good being usable in the second game.

### BRIEF DESCRIPTION OF THE DRAWINGS

FIG. 1 is a block diagram of an environment in which some embodiments may be practiced.

FIG. 2 is a block diagram that depicts the support game provider in some embodiments.

FIG. 3 is a block diagram that depicts the support game engine in some embodiments.

FIG. 4 is a block diagram depicting an offer wall engine in some embodiments.

FIG. 5 is a flowchart for providing multiple instantiations of a support game to different main games in some embodiments.

FIG. 6 depicts a support game configuration interface in some embodiments.

FIG. 7 depicts a virtual store in some embodiments.

FIG. 8 depicts player enhancements as being available in the virtual store in some embodiments.

FIG. 9 depicts an offer wall interface in some embodiments.

FIG. 10 is a block diagram of an analytics engine in some embodiments.

FIG. 11 depicts a game selection display for the support game in some embodiments.

FIG. 12 depicts a lottery ticket for the support game in some embodiments.

FIG. 13 depicts a slot machine for the support game in some embodiments.

FIG. 14 depicts a video poker game for the support game in some embodiments.

FIG. 15 depicts a black jack game for the support game in some embodiments,

FIG. 16 depicts a Pick6 lottery game for the support game in some embodiments.

FIG. 17 depicts lottery ticket for the support game in some embodiments.

FIG. 18 depicts a “wheel of fortune” style game in some embodiments.

FIG. 19 depicts a keno game in some embodiments.

FIG. 20 is a block diagram of an exemplary digital device.

### DETAILED DESCRIPTION OF THE INVENTION

In some embodiments, a support game supports multiple games. In one example, a first player may play a first main game and may have the option to play an instantiation of the support game. A second player may play a second main game that is different from the first main game, and may have the option to play a different instantiation of the support game. Both instantiations of the support game may allow similar gameplay experience to the first and second user.

The support game may encourage players to engage in the economy of a main game. An economy is any system whereby in-game progress may be measured. The main game economy may be measured by credits, level, points, experience, virtual items, achievements, virtual currency, or any other form of measure. Those skilled in the art will appreciate that a main game economy may be a combination of measurable units, including, for example, credits, achievements, virtual items, and/or any other kind of measureable unit. In some embodiments, players may play the support game for a chance to win or earn virtual items or credits that may be used in the main game. In one example, the players may be encouraged to play the support game for an opportunity to win or earn virtual items in the main game.

Different instantiations of the support game may be configured by different game providers. For example, a provider of a main game may configure a support game to enable certain types of game play, to offer various virtual items, and control the probability of a player winning or earning the virtual items. For example, a game provider may select among various games (e.g., games of chance) that may be available to a player within an instantiation of the support game. The game provider may also identify various virtual items that a player may earn or win within a support game or purchase through a virtual store. Further, the game provider may determine the probability that a player may win or earn one or more virtual items in the support game.

The provider of the support game may provide the main game providers information and recommendations that may encourage players to make purchases and grow revenue. For example, the provider of the support game may track the game play of a large number of players and identify the type of player and the type of situations in which players complete revenue-generating activities. By providing opportunities for a large number of players to play support games through a large number of main games, the support game provider is in a position to provide opportunities that encourage revenue growth.

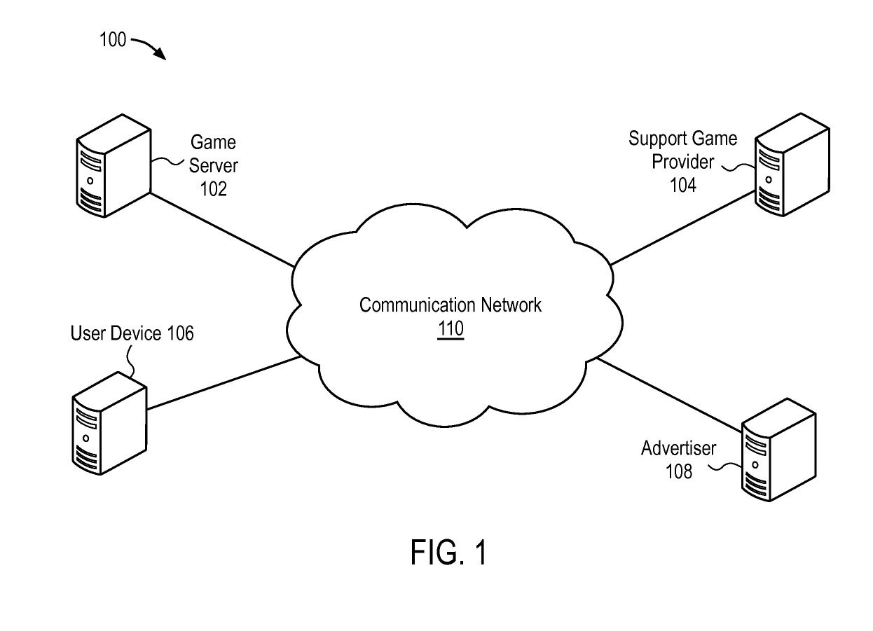

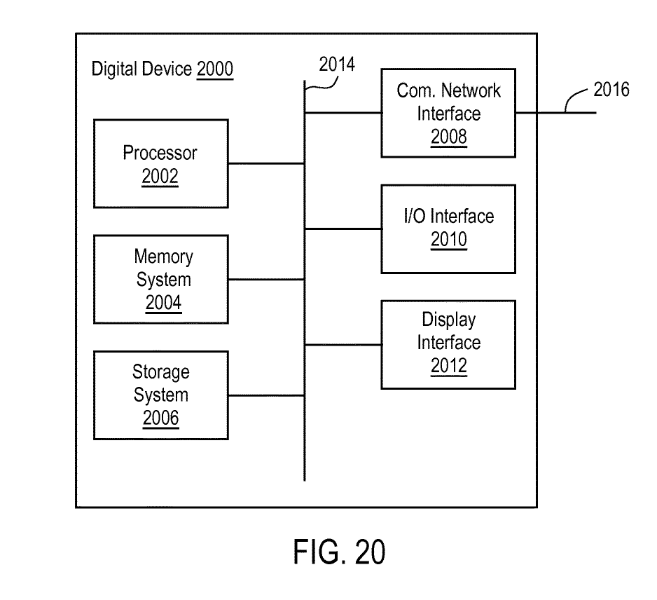

FIG. 1 is a block diagram of an environment 100 in which some embodiments may be practiced. The environment 100 comprises a game server 102, a support game provider 104, a user device 106, and an advertiser 108 which communicate over communication network 110. The game server 102, support game provider 104, user device 106, and/or advertiser 108 may be digital devices. A digital device is any device with a processor and memory. In some examples, a digital device may be a computer, laptop, notebook, netbook, workstation, terminal, smartphone, tablet, media device, music device, personal digital assistant, or the like. Digital devices are further described in FIG. 20.

In various embodiments, a player uses the user device 106 to play a main game provided by a game server 102. In one example, the user device 106 may allow the player to play a cloud-based game provided by the game server 102. In another example, the game server 102 may stream, download, or otherwise provide all or part of the main game to the user device 106 to allow the player to play the main game.

The main game may be any game with an economy. For example, the main game may be a first person shooter game, a puzzle game (e.g., matching shapes or items), a cooking game, farming game, city organization game, a simulation game, social game, or a massively multiplayer online game (MMOG). The economy of the main game may be any measurable unit, including but not limit to, levels, points, achievements, activities, virtual currency, virtual items, or the like.

The player of the user device 106 may engage a support game provided by the support game provider 104. In one example, the player may engage a button or any other interactive icon within the main game to activate (e.g., instantiate) the support game. The support game may be any game or activity.

In some embodiments, the support game may comprise a variety of games of chance (e.g., games that may be associated with a virtual casino). The player may play any number of games of chance in the support game. In the main game, a player may earn support credits or chips to play games associated with the support game. After the player has used the support credits, the player may return to the main game.

The player may earn support credits in any number of ways. For example, the player may win support credits in the support and/or main games, the player may purchase support credits, or a player may earn support credits through the passage of time or the completion of tasks. In one example of earning support credits, a player may engage in an advertisement (e.g., fill out an application for a major credit card) or perform other tasks (e.g., rate a product or view advertisements) to earn additional support credits to play the games associated with the support game.

The support game may be used to support the player's engagement in the main game. For example, the support game may encourage players to make purchases for the main game or to perform other revenue-generating functions. In some embodiments, the player may purchase measurable units for the economy of the main game. For example, the player may purchase virtual items, credits, virtual currency, or the like at a virtual store accessible through the support game. The player may also complete revenue-generating functions such as interacting with an advertisement, making a purchase of an advertised item or service, or completing a task that may result in revenue.

In various embodiments, the player may play games within the support game in order to win one or more measurable units in the main game. For example, the player may earn support credits to play a game of chance in a virtual casino provided by the support game. Each game of chance may require a limited number of support credits. In some embodiments, each game may provide the player an opportunity to win a measureable unit such as a virtual item for use in the main game, virtual currency for use in the main game, and/or additional support credits.

In some embodiments, player may play a game of chance in the support game in order to win tickets or other virtual currency that may be redeemed through a virtual store accessible through the support game. The player may use the virtual store to redeem the tickets or other virtual currency won in the game of chance in order to obtain measurable units to be used in the main game. For example, the player may win sufficient tickets to purchase a unique virtual item to be used in the main game (e.g., a sword, article of clothing, property, audio effect or the like).

The support game provider 104 may provide multiple instantiations of a support game which may be used in conjunction with different main games. For example, a first main game may allow players to play a first instantiation of the support game while the players in a second main game may play a different instantiation of the support game. The game play of the support game may be similar between the two instantiations but each main game provider may configure an instantiation different from the others. For example, one instantiation of a support game may allow players to play different games of chance including, for example, black jack, lottery, and poker while a different instantiation may allow players to play black jack, keno, and slot machines.

In various embodiments, the support game provider 104 may provide recommendations to the main game provider to increase revenue and/or revenue-generating activities. The support game provider 104 may receive information regarding the players who play the support game as well as the type of situations that encourage revenue-generating activities across multiple different instantiations. As a result, the support game provider 104 may recommend or generate promotions, advertisements, or offers to targeted players.

For example, the support game provider 104 may detect when a player has a limited number of support credits or chips. The support game provider 104 may then generate a promotion to encourage the player to purchase additional credits or chips. In one example, the promotion may comprise a price for triple the normal amount of credits or chips for a limited time. The support game provider 104 may also direct advertisements which indicate that a determined amount of support credits or chips may be earned if the advertisement is clicked or otherwise completed (e.g., 400 chips when the player joins Netflicks). The support game provider 104 may also generate offers for the player to make purchases or otherwise engage in revenue-generating behaviors.

In some embodiments, the support game provider 104 may generate the promotion, advertisement, or offer based on the history of the player (e.g., the propensity of which the player may engage in revenue-generating behaviors), demographics of the player, the history of similar players under similar circumstances, or the like. As a result, two players running out of chips may be offered different incentives to complete revenue-generating functions. For example, one player may have made purchases in the current instantiation of the support game or in other instantiations and as a result, the support game provider 104 may generate an offer for a high number of support credits while another player who rarely makes purchases may be offered an opportunity to win a unique virtual item that may be used in the main game in exchange for completing a revenue-generating activity. Those skilled in the art will appreciate that the support game provider 104 and/or the game server 102 may configure and/or generate any number of promotions, advertisements, and/or offers based on information received from the main game and/or support game.

The providers of the main game may control the support game to determine what activities are to be provided in the support game, the available options of revenue generation, and how the support game may engage and support the objectives of the main game. In one example, the providers of the main game may determine to allow certain activities such as specific games to be played in the support game while removing other activities (e.g., players may play a slot machine game of chance but not poker). In some embodiments, the providers of the main game may request that the support game provider 104 or game support providers create additional games and/or activities for engagement by the players of the main game.

The providers of the main game may also determine the available options of revenue generation. For example, a provider of a main game may determine that a limited number of advertisements and advertisement types (e.g., car advertisements but not advertisements for pharmaceuticals that are not FDA approved) may be displayed to players in the support game.

The providers of the main game may also determine how the support game may engage and support the objectives of the main game. In some embodiments, the providers may determine that a certain amount of support credits for the support game may be earned by players. This determination may be based on time (e.g., 10 support credits every day) or any other measure. The provider may also determine what may be purchased in a virtual store accessible by players in the support game. For example, the provider of the main game may determine what virtual items (e.g., unique, common, or special items) may be available to be purchased in the virtual store or to be won in the support game. In some embodiments, the provider may determine a probability that a virtual item may be won or purchased in the support game.

The advertiser 108 is any digital device that is configured to provide and/or collect advertisements, promotions, or offers which may appear in the main game or the support game. In some embodiments, the advertiser 108 provides one or more advertisements to the game server 102 and/or the support game provider 104. The game server 102 and/or the support game provider 104 may, in some embodiments, select advertisements from the advertiser 108 in order to control the appearance and type of advertisement during gameplay. The advertiser 108 may aggregate advertisements, promotions, and/or offers from multiple sources.

The communication network 110 may be any network such as a LAN or WAN. The wired and/or wireless devices may communicate over the communication network 110. In some embodiments, the communication network 110 is the Internet.

Although only a single game server 102, support game provider 104, user device 106, and advertiser 108 is depicted in FIG. 1, those skilled in the art will appreciate that there may be any number of game servers 102, support game providers 104, user devices 106, and advertisers 108. For example, the player may have the option to play different games provided by different game servers 102. Similarly, there may be multiple support game providers 104 providing different support games. Further, there may be any number of user devices 106 engaged in playing games. In some embodiments, one or more support game providers 104 and/or game server 102 may receive or retrieve advertisements from one or more advertisers 108.

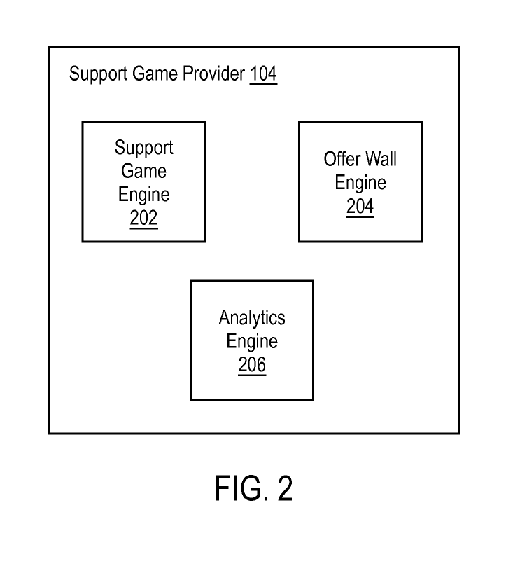

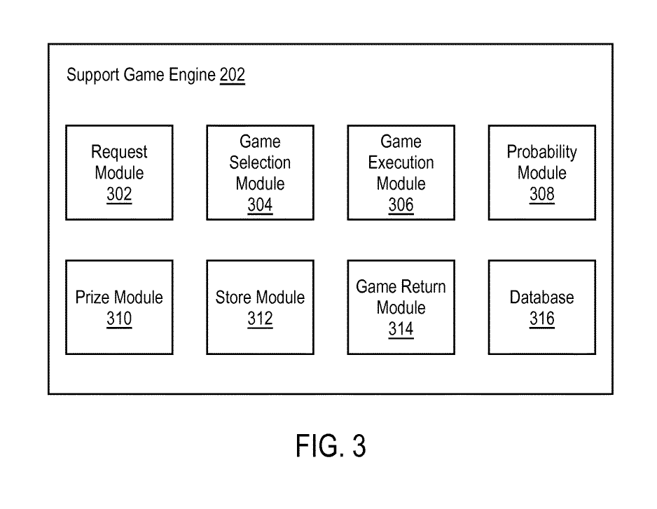

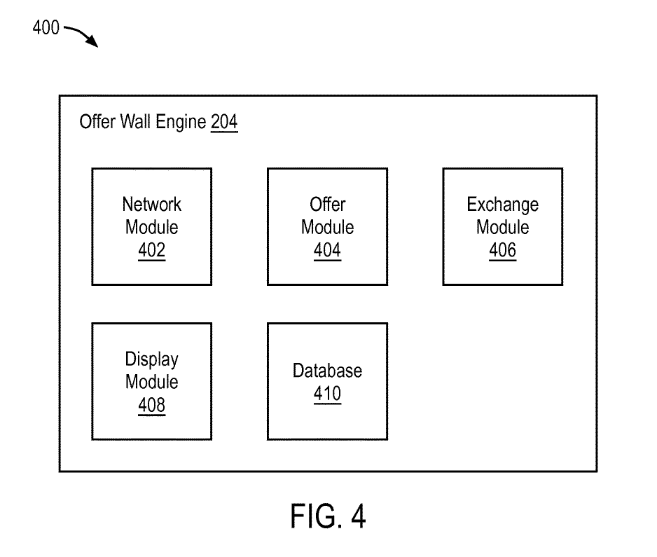

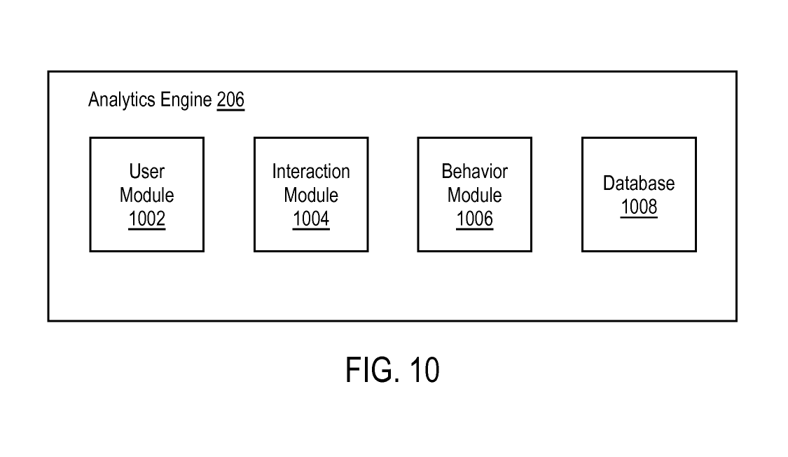

FIG. 2 is a block diagram that depicts the support game provider 104 in some embodiments. The support game provider 104 comprises a support game engine 202, an offer wall engine 204, and an analytics engine 206. The support game engine 202 is further described in FIG. 3. The offer wall engine is further described in FIG. 4. The analytics engine is further described in FIG. 10.

Those skilled in the art will appreciate that all or parts of the support game engine 202, the offer wall engine 204, and the analytics engine 206 may be streamed, downloaded, or otherwise provided to the game server 102 or the user device 106. For example, the game server 102 may configure a support game via the support game provider 104 which may then provide an instantiation of the configured support game to a player over the user device 106. In some embodiments, the support game provider 104 may provide the configured support game or an instantiation of the configured support game to the game server 102 which may then allow players to play the support game.

Further, alternative embodiments may comprise more, less, or functionally equivalent modules and still be within the scope of present embodiments.

FIG. 3 is a block diagram that depicts the support game engine 202 in some embodiments. The support game engine 202 comprises a request module 302, a game selection module 304, a game execution module 306, a probability module 308, a prize module 310, a store module 312, a game return module 314, and a database 316.

A request module 302 may be configured to receive requests from a player to engage in a support game. In one example, a player engaged in a main game may engage a button or other interface within the main game to access the support game. The request module 302 may receive the request and/or otherwise detect the interest of the player to engage in the support game. In some embodiments, the main game provider 102 may provide the support game request.

In response to the request or detected interest, the game selection module 304 may be configured to provide a game selection interface to the player (e.g., via the user device 106 and/or the game server 102). The game selection module 304 may allow the player to configure the experience and/or select activities to play within the support game.

In one example, the game selection interface may allow the player to select from among available games in the support game. When the player chooses not to play a particular game or activity, the player may, in some embodiments, return to the game selection interface to select another game or return to the main game.

The game execution module 306 is configured to execute the selected game. In some embodiments, the game selection module 304 receives a game selection from the player and instructs the game execution module 306 to execute the selected game.

Although multiple games or activities within a single instantiation of a support game is discussed, those skilled in the art will appreciate that there may be any number of activities or games associated with the instantiation of the support game.

In some embodiments, the game execution module 306 allows gameplay in exchange for a support credit, chip, ticket, or other measurable unit. The player may earn the measurable units within the main game or support game. In one example, every twelve hours the player earns a predetermined amount of measurable units (e.g., 20 chips every twelve hours) with which to play the selected game. When the player selects a game, the game execution module 306 may deduct a predetermined number of measurable units (e.g., two chips per play). In some embodiments, the player may determine how many measurable units to play. For example, the activity in the support game may be poker and the player may risk any number of chips in a single hand. Play may be limited based on the number of chips the player possesses.

The game execution module 306 may provide the player an opportunity to win a virtual good or measurable unit. For example, based on success or any other factor, the game execution module 306 may award a predetermined number of tickets with which the player may purchase virtual goods from a virtual store.

The game execution module 306 may determine the likelihood of winning an activity in the support game based on a win probability and may also determine what to award a player based on a loot probability. In one example, the game execution module 306 may determine if a player wins a game of chance based on a predetermined probability. The probability may be configured by the support game provider or the main game provider. The probability of winning may depend upon the identity of the player, past results, play history, success of others, purchase history, and/or any other factor(s).

Similarly, once the player wins, the game execution module 306 may determine what the player wins based on a loot probability. For example, once a player wins a game of chance, the game execution module 306 may award tickets, chips, a unique virtual item, or any other virtual good. There may be a low probability of winning a coveted unique virtual item to use within the main game and a higher probability of winning additional chips or tickets. The loot probability may be based on the player and the player's current status in the main game. For example, a player who is at a high level may have the opportunity to win or earn a virtual item that may be used by a high level character in the main game without upsetting the economy of the main game. A lower level character may win or earn a virtual item of lesser value. Those skilled in the art will appreciate that the probability that the player will win a game and the probability of what the player may win may be based on any number of factors.

The probability module 308 is configured to provide the game execution module 306 the win probability and the loot probability. In various embodiments, the main game provider may provide and/or configure the probabilities to be provided to the game execution module 306. For example, the main game provider may access the probability module 308 via the support game provider 104. The main game provider may determine the chances that a player may win a game based on any number of factors, the virtual good(s) that a player may win or earn, and a relative value that the player may win or earn. The main game provider may control and update the probabilities that are maintained by the probability module 308 at any time.

The prize module 310 may provide prizes to the players during the support game. The prizes may comprise, for example, virtual currency for use in the main game economy, virtual currency for use in the support game economy, or virtual goods to be used in the main game. A virtual currency for use in the main game economy may comprise points, credits, gold, loot, money, experience points, levels, achievement gains and the like. A virtual currency for use in the support game economy may comprise chips or support credits for playing games or otherwise interacting with the support game. Virtual goods, in some embodiments, may be any virtual item that may be used in the main game.

The store module 312 may provide a virtual store within the support game. The virtual store may allow the player to trade measurable units of the support game economy (e.g., chips or tickets) for virtual goods that may be used in the main game. In some embodiments, the player may purchase virtual goods and/or measurable units to continue playing games or activities associated with the support game or purchase virtual goods and/or measurable units that may be used in the main game.

In various embodiments, the support game may allow players to win tickets. The main game provider may control the probability of winning as well as the number of tickets that the player may win based on any number of factors. The tickets may be redeemable at the virtual store in exchange for virtual goods (e.g., virtual items, currency, and/or points) that may be used within the main game. The main game provider may determine what virtual goods will be available and the price that the goods are available.

In some embodiments, the virtual goods available in the virtual store may be different for different players. For example, the availability and price (e.g., number of tickets) of a virtual good may depend on the level of the player, the player's possession of another virtual item, friends of the player, achievements unlocked, or the like. The main game provider may configure the virtual store via the store module 312 in any number of ways.

The game return module 314 allows the player to return to the main game. In various embodiments, the game return module 314 enables the support game interface to display an icon or other mechanism to allow an indication that the player wishes to return to the main game. In some embodiments, the game return module 314 may return a player to the main game after a predetermined number of minutes of inactivity.

In some embodiments, the game return module 314 may actively encourage players to return to the main game by providing advertisements, offers, or promotions (e.g., triple points are available for a limited time if the player returns to the main game and completes a task). In one example, the game return module 314 may determine when to display an advertisement, offer, or promotion to the player (e.g., based on probability, past history of the players gaming habits). The game return module 314 may provide information in a news tracker to the player, generate a banner, and/or display a window over the support game to gain the player's attention. The game return module 314 may be configured by the main game provider.

In some embodiments, the game return module 314 may be configured to display information within the main game, including, for example, promotions or offers that are occurring in the support game, winnable virtual goods (e.g., a select virtual item being potentially winnable for a limited period of time) or the like. In some embodiments, the game return module 314 may return the player to the main game based on lack of measurable units necessary in the support game, expiration of a time limit, or the result of a game (e.g., the third bust in a specific game requires the player to return to the man game). Those skilled in the art will appreciate that there may be many ways in which a player can return to the main game.

The database 316 is any data structure configured to receive and store information. The database 316 may comprise the identities of past and existing players, player histories, a list of player who are prone to make purchases, or the like. The database 316 may also store the variety of different advertisements, offers, and/or promotions. When the main game provider controls the display, potential for winnings, and/or what the winning shall be, the main game provider may provide opportunities to players to make revenue-enhancing decisions without destabilizing the economy in the main game.

Further, alternative embodiments may comprise more, less, or functionally equivalent modules and still be within the scope of present embodiments.

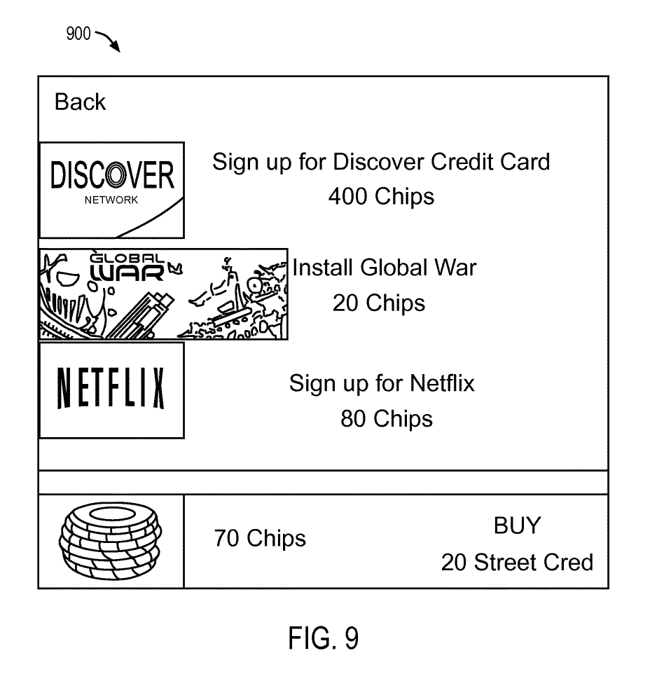

FIG. 4 is a block diagram depicting an offer wall engine 204 in some embodiments. The offer wall engine 204 comprises a network module 402, an offer module 404, an exchange module 406, a display module 408, and a database 410. In various embodiments, the offer wall engine 204 is configured to generate a graphical user interface depicting various advertisements and/or activities that may be selected by a player. By selecting and engaging in one or more activities, the player may earn or receive an opportunity to win chips, tickets, virtual goods, or the like. The offer wall is further described in FIG. 9.

The network module 402 is configured to interface with the main game or the support game and may receive a request to access the offer wall. In some embodiments, a player may indicate their interest in accessing the offer wall by clicking on a button or the like in the main game or the support game. Alternately, a player may receive an offer to view the offer wall. For example, when the player begins to run out of support credits (e.g., the number of support credits owned by the player falls below a predetermined threshold), the player may receive an offer to view the offer wall.

The network module 402 may also be configured to close the offer wall when the player indicates a desire to return to the main game or the support game. For example, the offer wall may include a button or other indicator that may be activated by the player.

The offer module 404 is configured to select or generate offers (e.g., from the database 410 or the advertiser 108 (see FIG. 1)) to display to the player. The offers on the offer walls may be paired with an offer return for viewing or completing a task associated with the offer. For example, the offer module 404 may select one or more offers to provide to the player (e.g., an advertisement to apply for a credit card). In exchange for completing the application for the credit card, the offer module 404 may provide a predetermined number of measurable units (e.g., 400 chips) to the player as the offer return.

The offer module 404 may receive an indication of interest from the player (e.g., the player may click on an offer on the offer wall) and the offer module 404 may redirect the player to a website and/or provide additional information necessary for the player to complete a task (e.g., make a purchase or apply for a service). The offer module 404 may detect when the task is completed (e.g., an advertiser sends a message to the offer module 404 indicating that the task is completed) and the offer module 404 may provide the offer return to the player (e.g., the predetermined number of measurable units).

The offer module 404 may also generate limited time promotions and provide additional information to players to encourage the players to view the offer wall and engage with an offer. For example, the offer module 404 may encourage players by offering an increased number of measurable units (e.g., triple the number of support credits normally available) for completing a task. The offer module 404 may provide a player an offer to display the offer wall or make additional promotions based on the number of measurable units owned by the player (e.g., the player has less than 10 chips left), the player's purchase history, similar player's purchase histories, the desirability of the offer, the advertisement, or the like.

Advertisers often pay the game provider and/or the support game provider revenue for completed applications. Different advertisements provide different revenue. As such, the offer module 404 may list offers based on the rate of return for advertisement completion thereby giving offers with the highest rate of return a preferred position on the offer wall. In some embodiments, the offer module 404 may list offers based on completion probability based on any number of factors in order to maximize overall return during gameplay.

The exchange module 406 is configured to offer the offer return associated with each offer. The offer return is what may be offered to the player in return for completing the revenue-generating activity. The offer return may be for measurable units that affect the support game economy (e.g., 100 chips), measurable units that affect the main game economy (e.g., 50 Zbucks), a virtual item, or other virtual goods.

In various embodiments, the main game provider may configure to the exchange module 406 to control the type of offer return that a player may receive. For example, the main game provider may allow the player to win a considerable number of chips that are usable in the support game economy but only a limited value of virtual goods that are usable in the main game economy to avoid inconsistencies of play within the main game.

In some embodiments, the main game provider may also control when certain promotions are made. For example, the main game provider may configure the exchange module 406 to offer a multiple of virtual goods only to certain players in certain circumstances (e.g., a player may be offered 4×400 tickets for completing a credit card application when the player has made previous purchases and there is a cross-promotion occurring in the main game).

The main game provider may also control a probability when increased offer returns are offered. For example, the main game provider may configure the exchange module 406 to offer enhanced offer returns only 5% of the time in certain circumstances (e.g., 5% of the time when the player has never made a purchase before and the player has over 100 chips left) and 20% of the time in other circumstances (e.g., 20% percent of the time when the player has less than 10 chips left and the player has recently spent a large number of chips to win a unique virtual item usable in the main game).

The display module 408 is configured to generate the offer wall as well as the returns and any additional promotions. For example, the offer wall may comprise one or more advertisements. The display module 408 may display an offer return in conjunction with each advertisement indicating that the player may earn the return for completing an activity associated with the advertisement.

In some embodiments, the display module 408 retrieves or otherwise provides advertisements to the offer wall from an advertiser 108 and/or the database 410. The display module 408 may also retrieve the offer return from the exchange module 406 and/or the database 410.

The database 410 is any data structure that may store associations between advertisements and offer returns, advertisements, probability that certain advertisements and/or offers will be made, player identities, player histories, and/or strategies for promoting revenue growth through the offer wall which may be implemented by the offer module 404 based on the activities of a plurality of players and revenue enhancement.

Further, alternative embodiments may comprise more, less, or functionally equivalent modules and still be within the scope of present embodiments.

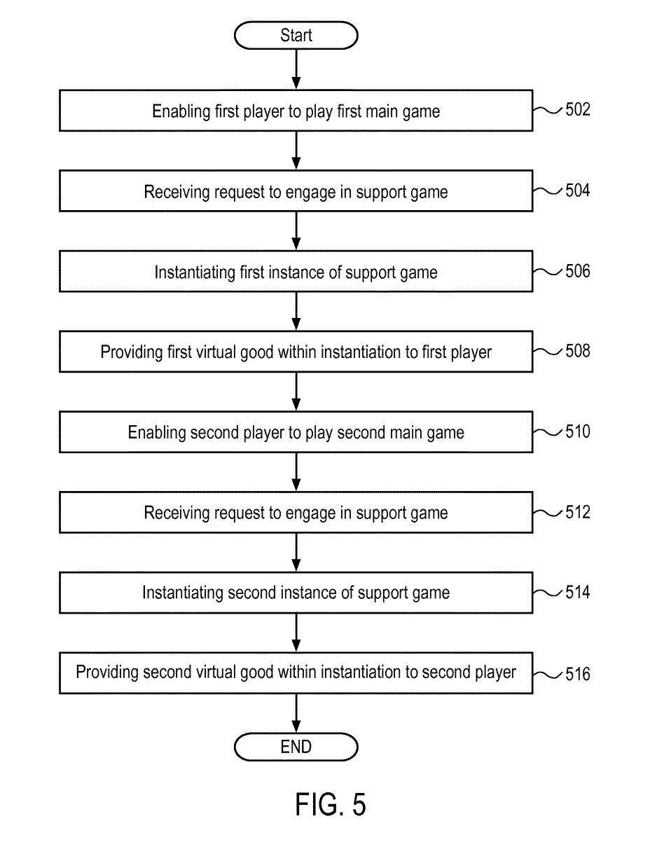

FIG. 5 is a flowchart for providing multiple instantiations of a support game to different main games in some embodiments. In step 502, the game server 102 (see FIG. 1) enables a first player to play a first main game. In one example, a player accesses a main game through the user device 106. In some embodiments, the user device 106 accesses a social game on the game server 102 via the communication network 110.

In step 504, the support game engine 202 may receive a request to engage in a support game. In one example, the request module 302 of the support game engine 202 may receive a request from the player. In some embodiments, the first main game may offer the player an opportunity to engage in the support game either by, for example, providing a button or other interactive element in the first main game or by displaying an offer to play the support game to the player. The player may provide a request to access the support game by clicking or otherwise interacting with the main game.

In step 506, in response to the request, the game execution module 306 may instantiate (i.e., create an instance of) the support game thereby allowing the player to engage in the support game. The player may then engage in one or more activities in the support game. The support game may comprise any number of games.

In one example, the support game is a virtual casino. The player may, in this example, earn chips to play various games within the virtual casino. The support game may allow the player a chance to win tickets that are redeemable in a virtual store. The virtual store may comprise virtual items that are usable in the first main game.

If the player runs out of chips and wishes to continue to play games of chance within the virtual casino, the player may purchase or earn additional chips by completing revenue-generating activities. For example, the virtual casino may display the offer wall whereby the player may select an advertisement and complete a related task in order to receive additional chips. The player may then continue playing the games of chance within the virtual casino until a desired number of tickets are earned or the player again runs out of chips.

In step 508, the prize module 310 provides a first virtual good within the support game instantiation to first the first player. In some embodiments, the first player plays games of chance within the virtual casino and wins a virtual good (e.g., currency usable in the support game, currency usable in the main game, a virtual item usable in the main game, points, credits, or achievements). The first player may also win tickets that are usable to buy a virtual good in the virtual store.

In step 510, a second game server 102 may enable a second player to play a second main game. The first main game and the second main game may be unrelated. For example, the first main game may be a game allowing a player to grow crops in a virtual farm while the second main game may be a game allowing a player to create a city and simulate the citizens. In step 512, the support game engine 202 may receive a request from the second player to engage in the support game. The support game may be the same support game that is played by the first player.

In step 514, the support game engine 202 instantiates a second instance of the support game for play by the second player. Although both instantiations may depict a virtual casino, the instantiations may be configured differently. For example, the first main game provider may configure the first instantiation to play selected games of chance, offer chances to win or earn specific virtual items that may be used in the virtual farm, and configure the probability of the first player of winning the virtual item. The second main game provider may configure the second instantiation to play selected games of chance that are different from the first instantiation. Further, the second main game provider may configure the second instantiation to offer chances to win or earn virtual items that may be used in the virtual city. The second main game provider may configure different probabilities of winning the virtual item. Although both the first and second instantiations may include virtual stores, the virtual stores may offer different virtual goods.

In some embodiments, the two instantiations may offer different advertisements in the offer wall, include different returns, and offer different enticements for the players to engage in revenue-generating activities. Based on information received from player behavior and success of revenue generation over a plurality of different instantiations, the support game engine 202 may offer recommendations or promotions to the different players to encourage further engagement and completion of revenue-generating activities.

In step 516, the support game engine 202 provides a second virtual good within the instantiation to the second player. The second player may win or earn the virtual good by winning a game of chance within the virtual casino or purchasing the virtual good in the virtual store.

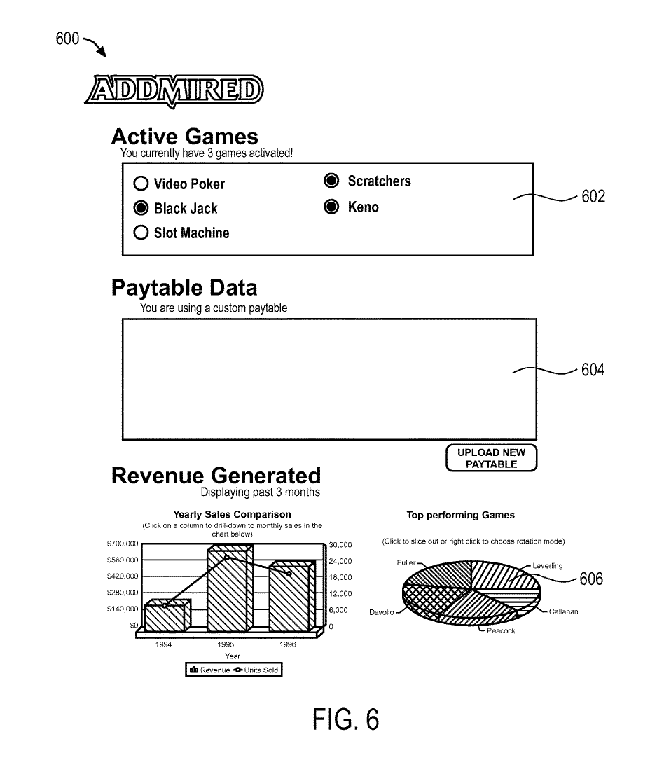

FIG. 6 depicts a support game configuration interface 600 in some embodiments. In various embodiments, the main game provider may configure the support game through the use of the support game configuration interface 600. The support game configuration interface 600 may comprise a game selection area 602, a paytable 604, and a revenue report 606.

The game selection area 602 may allow a main game provider to select which games will be offered in the support game. In this example, the main game provider has selected Black Jack, Scratchers, and Keno but not Video Poker or Slot Machine. As a result, the selected games will be available in the support game. Those skilled in the art will appreciate that any number of different games may be selected or deselected in the game selection area 602.

The paytable 604 allows the main game provider to identify what the player may win in a game and the chances of winning (e.g., the win probability and the loot probability). For example, the main game provider may generally allow players to win currency usable in the support game in the games selected in the game selection are 602. A main game provider, however, may also allow players to win virtual goods usable in the main game (e.g., a machine gun or currency). Through the use of the paytable, the main game provider may control the activities and winnings of the support game in order to protect or avoid destabilization of the main game economy while encouraging revenue growth.

In some embodiments, the main game provider may configure the main game to offer certain items to one subset of characters while offering something else to another subset. For example, the main game provider may offer virtual goods of limited value to new players or players or low level in the main game. Experienced players, however, may require additional virtual items or virtual goods of greater value to encourage their engagement with the support game.

The main game provider may also provide the probability of winning in the support game. For example, the main game provider may set the probability of winning a unique virtual item (e.g., a magical wand) as 25% in order to encourage players to play the support game and engage in revenue-generating behavior in the hopes of winning the unique virtual item. The probabilities of winning may also be based on the player (e.g., player level or achievement), player past purchases, past wins, or the like.

The revenue report 606 may depict the amount of revenue generated by players associated with the main game as well as the results of choices made by the main game providers (e.g., selected games, the configuration of the probabilities of winning, the virtual goods offered). The revenue report 606 may contain any information with which the main game provider may base decisions in order to encourage revenue growth.

Those skilled in the art will appreciate that the main game provider may configure the support game in any number of ways including by adding graphics to the support game to better interface with the main game, providing new activities to play within the support game, controlling the type and quantity of offers that are displayed to the players, controlling the offer return, controlling the probability that offers or promotions are made, and the like.

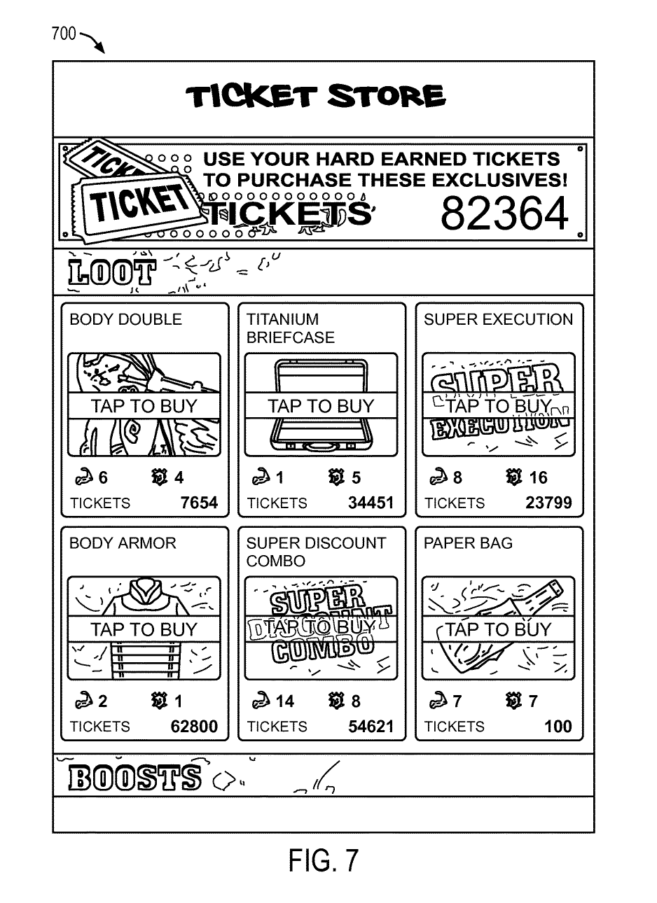

FIG. 7 depicts a virtual store 700 in some embodiments. In some embodiments, the player may request access to the virtual store 700 in order to redeem measurable units (e.g., tickets) that were earned, won, or purchased in the support game. The virtual store 700 may comprise any kinds of virtual goods that may be used in the main game and/or the support game. For example, the virtual store 700 may allow a player to buy a body double device to be used in the main game in exchange for 7,654 tickets. The player may also purchase a titanium briefcase, body armor, a paper bag, and the like. The main game provider may configure what is offered in the virtual store 700 and the number of tickets (or other measurable units) which are required to make a purchase.

In some embodiments, the virtual store 700 may trigger the offer wall to display offers to the player when the player's number of tickets is low or the player attempted to purchase a virtual good but was denied due to lack of tickets.

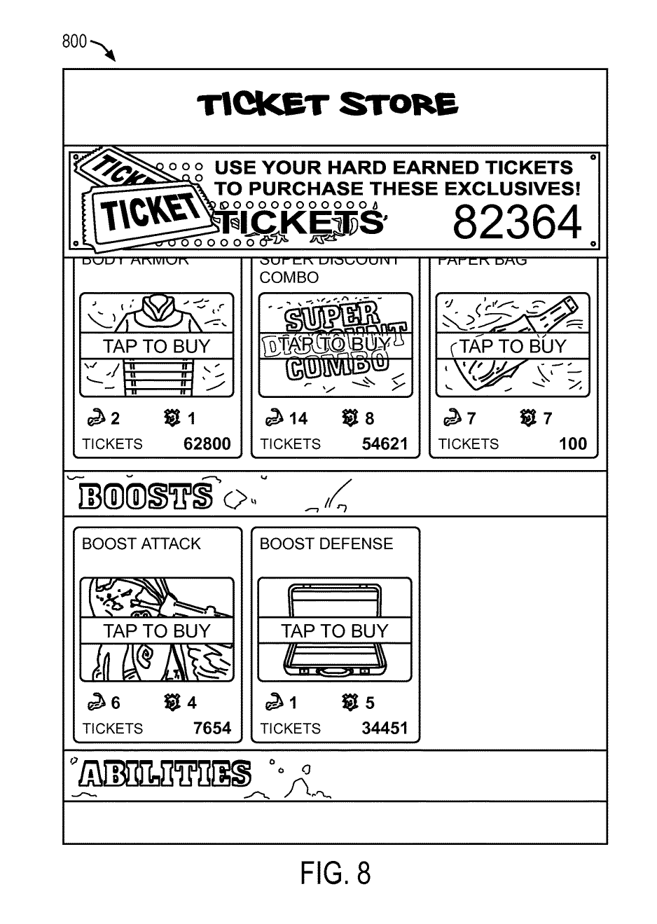

FIG. 8 depicts player enhancements as being available in the virtual store 800 in some embodiments. Those skilled in the art will appreciate that any virtual goods may be offered in the virtual store 800 including, but not limited to, virtual items (e.g., body armor), skills usable in the main game (e.g., combination fighting skills), player enhancements (e.g., boosts for attack and defense), player ability upgrades (e.g., jump height), and the like.

In various embodiments, the player is encouraged to make purchases to afford virtual goods in the virtual store 800 so that the experience in the main game is more enjoyable, rewarding, and engaging.

FIG. 9 depicts an offer wall interface 900 in some embodiments. The offer wall interface 900 comprises a variety of advertisements and returns for completing tasks associated with the advertisement. For example, the offer wall interface 900 offers a return of 400 chips usable in the support game (e.g., to play more games of chance for a chance to win larger virtual goods) in return for the player clicking on the Discover Network link and signing up for a Discover credit card. The offer wall interface 900 also offers a return of 20 chips if the player installs the game “Global War.”

In various embodiments, the offer wall interface 900 may allow players to make purchases of measurable units usable in the support game by spending virtual currency from the main game. For example, the player may spend 20 “street cred” which is earned in the main game in order to buy 70 chips usable in the support game. The main game providers may configure the support game to accept or make promotions in many ways. In another example, the main game provider may configure the support game to make offers in exchange for measurable units that were earned in the main game.

FIG. 10 is a block diagram of an analytics engine 206 in some embodiments. The analytics engine 206 may comprise a user module 1002, an interaction module 1004, a behavior module 1006, and a database 1008. In some embodiments, the analytics engine 206 may make recommendations to the main game provider to increase revenue. For example, the analytics engine 206 may collect information regarding circumstances, activities, and promotions that tend to encourage players to complete revenue-generating activities. The main game provider may configure the support game based on one or more recommendations. In some embodiments, the main game provider may increase returns for the support game that encourage the players to engage in revenue-generating activities without destabilizing the main game.

The analytics engine 206 is configured to analyze the success or failure of promotions, offers, and the like in promoting revenue-generating activities. In various embodiments, the analytics engine 206 may control the offer module 404 of the offer wall engine 204 to make promotions, select advertisements, or offer returns based on the player, player history, similar player behavior, virtual items available, type of main game, promotions in the main game, or the like. Those skilled in the art will appreciate that the analytics engine 206 may perform various statistical modeling and heuristics based on the behavior of multiple players in different instantiations of the support game in order to generate recommendations and/or control the support game as to encourage revenue generation.

The user module 1002 is configured to identify players, the current status of players in the main game, the current status of players in the support game, and the like. In one example, the user module 1002 may identify a player and determine that the player is running low on chips. The user module 1002 may configure the support game to offer the player revenue-generating activities to increase the player's number of chips. If the player completes the activities, the user module 1002 may track that the promotion was successful in that circumstance. If the player does not complete the activity, the user module 1002 may also track that the promotion was unsuccessful.

The interaction module 1004 may track and assess past interactions of the one or more players to determine what circumstances one or more players tend to make revenue-generating activities. For example, the interaction module 1004 may determine that a subset of players is attracted to a particular advertisement, return, or promotion. The interaction module 1004 may track that behavior and provide recommendations or direction to encourage those advertisements, returns, or promotions. In some embodiments, the interaction module 1004 may change or recommend changes to win and/or loot probabilities.

The interaction module 1004 may also track how multiple players may interact together to accomplish a goal. In some embodiments, the support game may allow multiple players to play together. For example, players may play poker against each other and gain extra measurable units when they beat a friend. Offers may be made by the support game to the players who compete with or against each other so that the players may continue playing, to gain an advantage, or prevent a disadvantage.

The behavior module 1006 is configured to track and assess player behavior. In various embodiments, the behavior module 1006 determines the likelihood that one or more players are likely to engage in revenue-generating activities based on past history with the main game, the support game, interactions with offers, or interactions with promotions. For example, a player with a history of installing new games in order to earn additional chips may be likely to install another new game or an enhancement to a recently installed game in exchange for additional chips. The behavior module 1006 may also be configured to track past and current behavior of similar players to determine what activities, games, promotions, advertisements, or returns are likely to result in the player engaging in revenue-generating activities.

Those skilled in the art will appreciate that the analytics engine 206 may assess when offers or promotions are successful and when the offers and promotions are not successful. The analytics engine 206 may configure the support game in response to the assessment and/or make recommendations to the main game provider. For example, the analytics engine 206 may change the return to maximize revenue, encourage players to play games in the support game by increasing payouts or increasing the probability of winning a payout, increase the price for virtual goods in the virtual store, and the like. The analytics engine 206 may assess the identities, interactions, and behaviors of multiple players over a plurality of games in order to develop a model of behavior for revenue generation. The support game and/or the main game providers may use the model to base determinations of what to offer the players, when the offer should be made, the chances of success and so forth in order to increase revenue generation.

Further, alternative embodiments may comprise more, less, or functionally equivalent modules and still be within the scope of present embodiments.

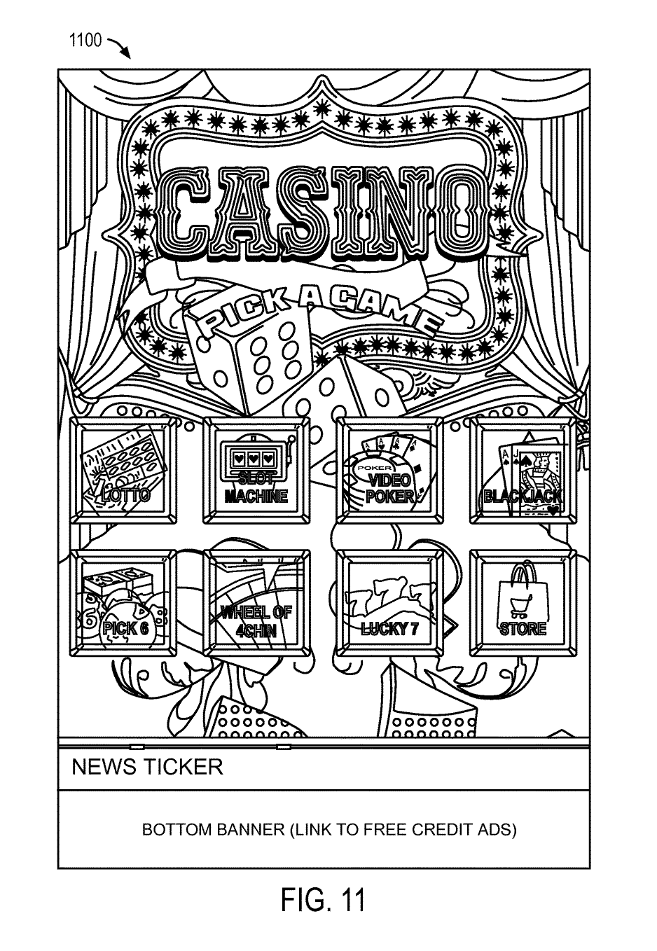

FIG. 11 depicts a game selection display 1100 for the support game in some embodiments. In various embodiments, a player plays a main game and is invited to play the support game. The support game may comprise a virtual casino where the player may play various games of chance. For example, the player may play a lottery, a slot machine, a video poker, black jack, Pick 6, Wheel of Fortune, Lucky 7, or any number of other games. The player may also choose to access a virtual store.

In various embodiments, the player may play different games of chance to win virtual items to be used in the main game, chips, or tickets for an opportunity to continue play of the games of chance. For example, when a player selects the lotto game, each play may require a predetermined number of chips. The player may earn chips in the main game and/or the support game.

The game selection display 1100 may also recommend to the player certain games of chance or featured virtual items. For example, the main game provider may configure the game selection display 1100 to advertise one or more virtual items that the player may win or earn. The main game provider may also configure the game selection display 1100 to depict images from the main game for a consistent or contextual experience between the main game and the support game(s).

The game selection display 1100 may depict a news ticker and bottom banner. The news ticker may contain information regarding the main game (e.g., current promotions or events in the main game) or may contain information regarding the support game (e.g., current promotions or events in the support game). The bottom banner may depict an advertisement or other promotion to encourage a player to make purchases, complete advertisements, engage in the main game, or engage in the support game.

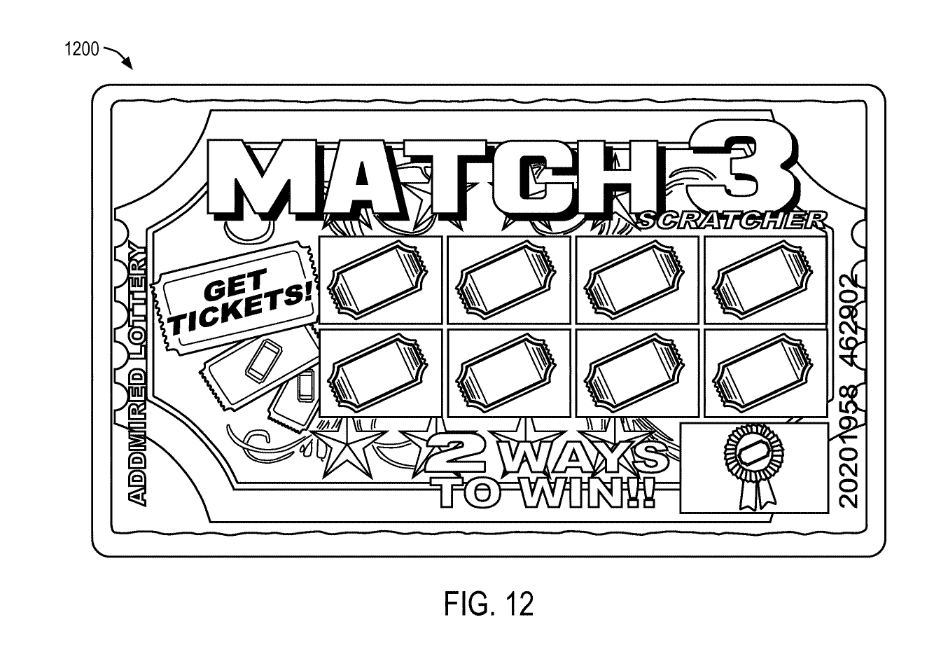

FIGS. 12-19 depict various games of chance that may be played within a virtual casino. The games of chance may allow a player to win chips, tickets, and/or virtual goods. In some embodiments, each play of a game within the virtual casino cost one or more chips. As described herein, chips may be earned or purchased. The player may win tickets that may be exchangeable (e.g., through the virtual store) for virtual goods and/or chips.

Each of the various games may provide an option to return to the game selection display 1100, the virtual store, and/or the main game. Further, each of the various games may depict news or other information at the bottom of the game. The information may indicate promotions, offers, or other information related to the support game and/or the main game. In some embodiments, the support game may track the number of chips available to a player and, when the player's number of chips is low, display a promotion to encourage the player to purchase or earn additional chips. For example, when the player's chips are low, the news tracker at the bottom of the game selection display 1100 and/or at the bottom of an activity in the support game may indicate that a multiple (e.g., 3×) chips or tickets may be earned for a limited time by viewing or completing a task associated with an advertisement (e.g., completing an application for membership or an organization, purchase an item, or request a new credit card).

Those skilled in the art will appreciate that information within a news ticker at the bottom of an activity of a support game may be of any size. In some embodiments, the new ticker may display a summary of a promotion that encourages the player to engage the news ticker (e.g., click on the news ticker and/or an arrow to receive additional information). In one example, a player may click on the arrow which scrolls open the news ticker over the activity of the support game to display additional information. While the news ticker is in the open position, the underlying activity of the support game may or may not be paused. In some embodiments, the player may configure the support game to continue playing in the background, pause the activity of the support game, and/or control how the news ticker is displayed or opened.

Those skilled in the art will appreciate that each of the activities within the support game may include a social element where players may compete with or against each other. For example, one or more of the various activities may depict a leaderboard identifying those players who play the activity more than other players, identifying the players who win the most playing the activity, and/or depict the what the players won (e.g., 2,000,000 tickets).

FIG. 12 depicts a lottery ticket 1200 for the support game in some embodiments. The lottery ticket may be a scratcher or may require a player to select numbers that will be matched in another lottery system. In some embodiments, the player may “spend” one or more chips for the opportunity to play the lottery ticket 1200. The player may utilize a mouse, keyboard, touchscreen, or any other user input (e.g., I/O device) to select or “scratch” off sections of the lottery ticket 1200. If the player wins, the player may earn virtual goods (e.g., virtual items, points, or currency) that may be used in the main game. In some embodiments, the player may win chips to continue playing one or more activities in the support game. The player may also win tickets which may be redeemed in the virtual store. Those skilled in the art will appreciate that a player may win any, some, or none of the virtual goods, chips, and/or tickets.

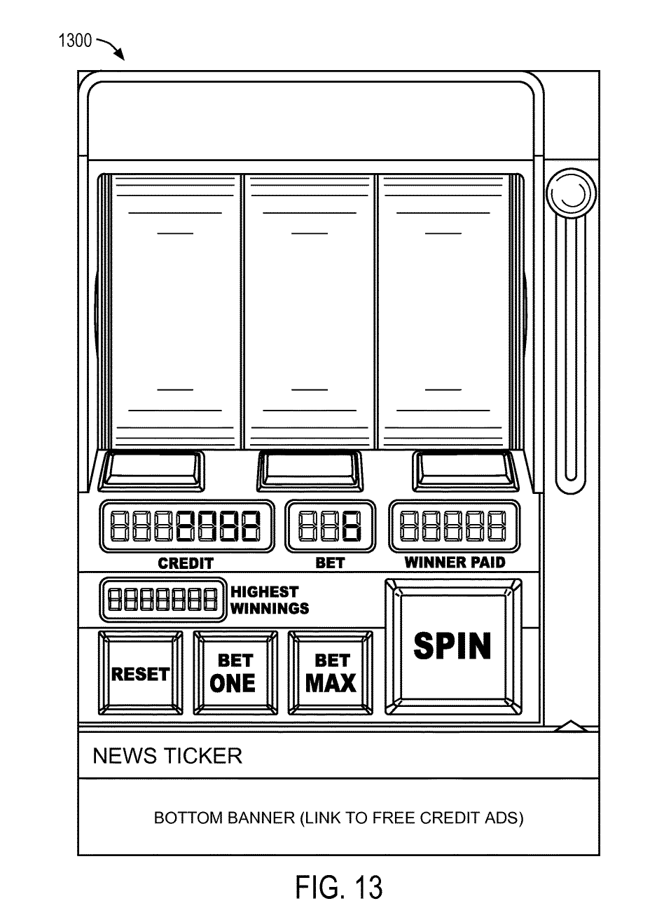

FIG. 13 depicts a slot machine 1300 for the support game in some embodiments. The slot machine 1300 may resemble any slot machine (e.g., of the type found in Las Vegas) and allow players to select any number of wheels for the chance to win tickets, chips, or virtual goods. In one example, the player may hold wheels, operate the level, control bets, and initiate a spin with a mouse, keyboard, touchscreen, or any other user input (e.g., I/O device).

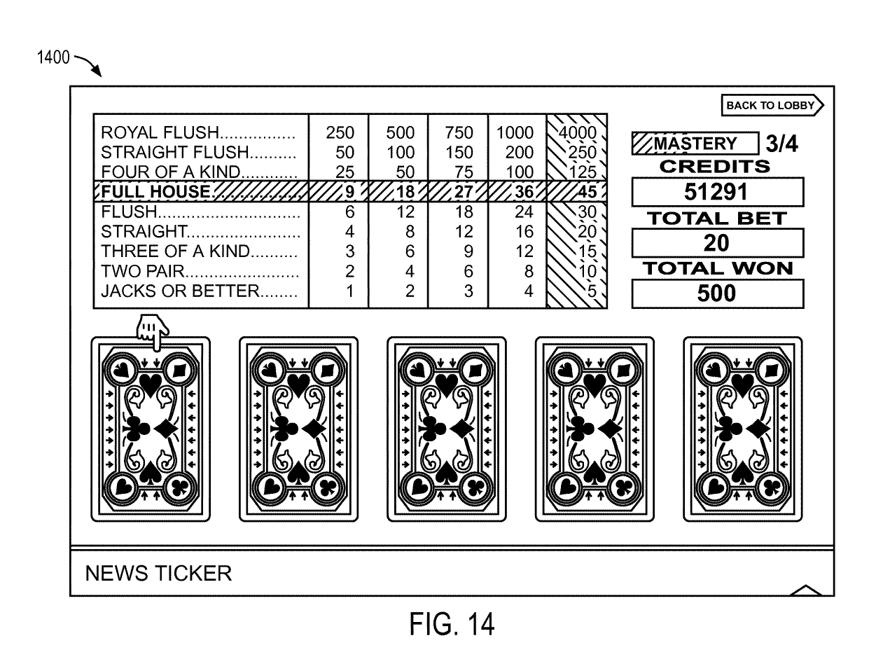

FIG. 14 depicts a video poker game 1400 for the support game in some embodiments. The video poker game 1400 may allow a player to play one or more different types of poker (e.g., Texas Holdem, Omaha, 7-card stud, 5-card stud, Triple Draw, Crazy Pineapple, Draw, or Razz). The video poker game 1400 may allow a player to control the total number of bets, select cards, make plays, and/or initiate the game through a mouse, keyboard, touchscreen, and/or any other user input (e.g., I/O device).

Like in all games of chance, the main game provider may control the odds of winning as well as the relative payouts. As depicted in FIG. 14, the video poker game 1400 depicts a table indicating what may be won for different hands depending on the size of the bet (e.g., 4000 tickets, credits, or other virtual currency for a Royal Flush).

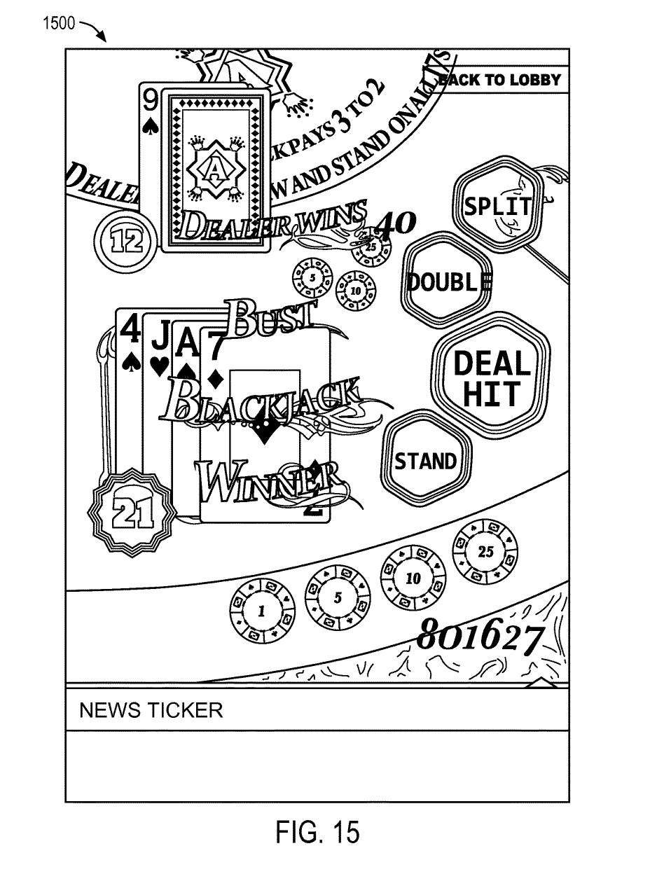

FIG. 15 depicts a black jack game 1500 for the support game in some embodiments. The black jack game 1600 may allow players to play one or more different types of black jack games. The player may control the game (e.g., select cards, hold, split, double, stand, or hit) through a mouse, keyboard, touchscreen, and/or any other user input (e.g., I/O device).

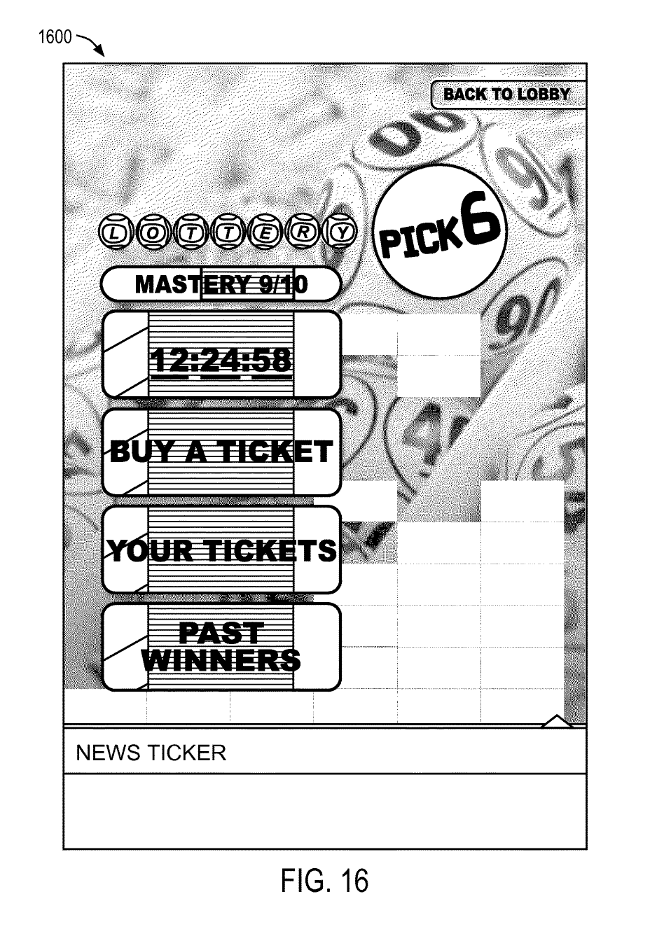

FIG. 16 depicts a Pick6 lottery game 1600 for the support game in some embodiments. In some embodiments, the Pick6 game 1600 allows a player to buy a lottery ticket, view pending tickets, view past winners and their winnings, and the like. In one example, a player may click or otherwise activate an option to buy ticket. Once activated, the support game may display the lottery ticket.

Those skilled in the art will appreciate that the game “pick6” may be displayed where players may select six numbers in a lottery-style game, any type of lottery may be provided in the support game. For example, the player may select any number of numbers and play any kind of lottery.

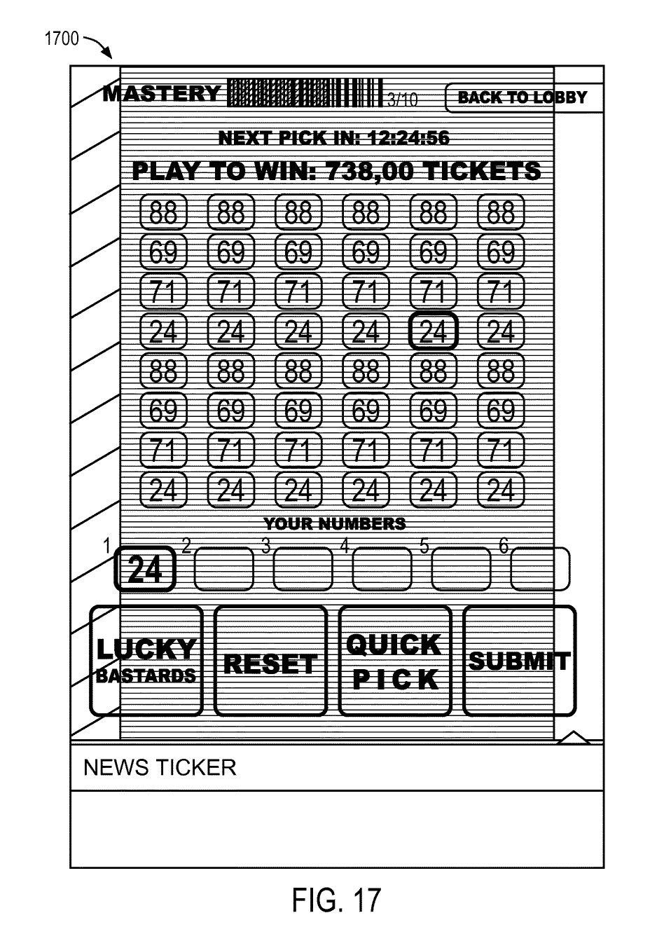

FIG. 17 depicts lottery ticket 1700 for the support game in some embodiments. The lottery ticket 1700 allows a player to select six numbers with the hope of matching numbers which are determined or drawn at predetermined intervals. In this example, a new drawing occurs in twelve hours, twenty-four minutes, and fifty-six seconds.

Each of the various games of chance may track the player's progress and provide special promotions to the players for continued play or success. For example, a virtual game may include a mastery bar that tracks the number of times the player has won and/or played the game. As the player exceeds a predetermined number of plays or wins of the game, the player may earn the opportunity to play for additional chips, tickets, or virtual goods. For example, once mastery is achieved, the lottery ticket 1300 may allow the player to win additional chips, tickets or virtual goods (e.g., 3× winnings of tickets) for a limited time period. In another example, once mastery is achieved, the lottery ticket 1300 may advertise that, for a limited time, the player may win a chance to play for a unique virtual item that be used within the main game. Those skilled in the art will appreciate that any loyalty-type program may be used to reward behavior, entice additional play, and encourage players to make purchases.

The lottery ticket 1700 may also allow players to select numbers through a mouse, keyboard, touchscreen, or any other user input (e.g., I/O device) or to automatically select numbers through a Quick Pick function.

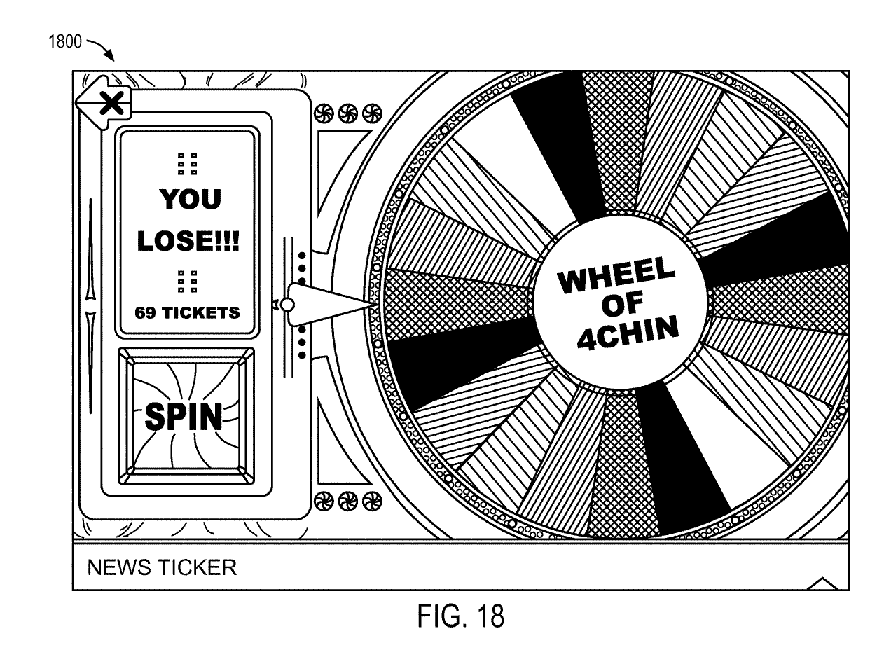

FIG. 18 depicts a “wheel of fortune” style game 1800 in some embodiments. In the “wheel of fortune” style game 1800, the player may purchase (e.g., through credits, chips, tickets or other virtual currency) a spin for a chance to win a prize. In one example, the wheel may be depicted to spin and the player may win (or lose) depending on what portion of the wheel that an arrow points towards.

Those skilled in the art will appreciate that the activities in the support game may be completely dependent on skill, completely dependent on luck, or a combination of skill and luck. Further, activities of the support game may be simple or complex. In the “wheel of fortune” style game, a player may simply command the wheel to spin for a chance to win. In a poker style game, the player may affect their chances of winning by making strategic choices during the poker game.

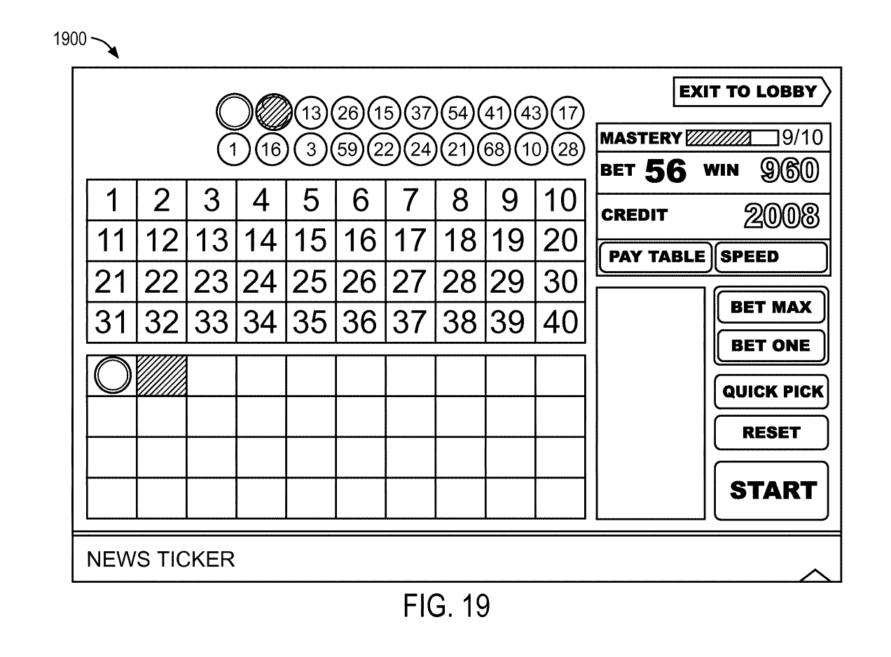

FIG. 19 depicts a keno game 1900 in some embodiments. The keno game 1900 may be a lottery or bingo game whereby players may select numbers before or during a selection of numbers of the keno game 1900. In one example, the player may select numbers, control the speed of the game, control their bet, choose the computer to automatically select a number (e.g., “quick pick”), view the paytable or the like by interacting with the keno game 1900 with a mouse, keyboard, touchscreen, and/or any other user input (e.g., I/O device).

The player may win or lose based on paytables configured by the main game provider. The paytables may indicate what the player may win and under what circumstances (e.g., the number of correct choices the player selects).

Those skilled in the art will appreciate that there may be many different types of games or activities in the support game and are not limited to games of chance or those depicted in FIGS. 11-19.

FIG. 20 is a block diagram of an exemplary digital device 2000. The digital device 2000 comprises a processor 2002, a memory system 2004, a storage system 2006, a communication network interface 2008, an I/O interface 2010, and a display interface 2012 communicatively coupled to a bus 2014. The processor 2002 is configured to execute executable instructions (e.g., programs). In some embodiments, the processor 2002 comprises circuitry or any processor capable of processing the executable instructions.

The memory system 2004 is any memory configured to store data. Some examples of the memory system 2004 are storage devices, such as RAM or ROM. The memory system 2004 can comprise the ram cache. In various embodiments, data is stored within the memory system 2004. The data within the memory system 2004 may be cleared or ultimately transferred to the storage system 2006.

The storage system 2006 is any non-transitory storage configured to retrieve and store data. Some examples of the storage system 2006 are flash drives, hard drives, optical drives, and/or magnetic tape. In some embodiments, the digital device 2000 includes a memory system 2004 in the form of RAM and a storage system 2006 in the form of flash data. Both the memory system 2004 and the storage system 2006 comprise computer readable media which may store instructions or programs that are executable by a computer processor including the processor 2002.

The communication network interface (com. network interface) 2008 can be coupled to a network (e.g., communication network 114) via the link 2016. The communication network interface 2008 may support communication over an Ethernet connection, a serial connection, a parallel connection, or an ATA connection, for example. The communication network interface 2008 may also support wireless communication (e.g., 802.11 a/b/g/n, WiMax). It will be apparent to those skilled in the art that the communication network interface 2008 can support many wired and wireless standards.

The optional input/output (I/O) interface 2010 is any device that receives input from the user and output data. The optional display interface 2012 is any device that is configured to output graphics and data to a display. In one example, the display interface 2012 is a graphics adapter. It will be appreciated that not all digital devices 2000 comprise either the I/O interface 2010 or the display interface 2012.

It will be appreciated by those skilled in the art that the hardware elements of the digital device 2000 are not limited to those depicted in FIG. 20. A digital device 2000 may comprise more or less hardware elements than those depicted. Further, hardware elements may share functionality and still be within various embodiments described herein. In one example, encoding and/or decoding may be performed by the processor 2002 and/or a co-processor located on a GPU (i.e., Nvidia).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1-23. (canceled)

24. A computer-implemented method, comprising:
enabling a user to interact within a virtual environment,
wherein the virtual environment comprises a plurality of measurable units configured to measure progress of the user within the virtual environment;
monitoring at least one characteristic of the user within the virtual environment;
detecting when the at least one characteristic of the user is below a predetermined threshold within the virtual environment, and, based thereon:
displaying a first interactive rewarded playable unit within at least a portion of the virtual environment,
wherein the user plays the first interactive rewarded playable unit to generate additional measurable units for use within the virtual environment by achieving a predetermined milestone in the first interactive rewarded playable unit;
activating the first interactive rewarded playable unit in response to a request by the user to engage in the first interactive rewarded playable unit;
displaying a second interactive rewarded playable unit within at least a portion of the first interactive rewarded playable unit at one or more intervals while the user engages in the first interactive rewarded playable unit; and
activating the second interactive rewarded playable unit in response to a request by the user to engage in the second interactive rewarded playable unit.

25. The method of claim 24, wherein the virtual environment comprises a main game.

26. The method of claim 24, wherein the first interactive rewarded playable unit comprises one of a fully-featured standalone game and a feature-limited demonstration of a fully-featured game.

27. The method of claim 26, wherein playing the first interactive rewarded playable unit incentivizes the user to download the fully-featured game for use as the virtual environment.

28. The method of claim 24, wherein the second interactive rewarded playable unit is displayed to the user when the user fails to achieve the predetermined milestone in the first interactive rewarded playable unit.

29. The method of claim 24, wherein the second interactive rewarded playable unit comprises an interactive rewarded advertising unit.

30. The method of claim 29, wherein the interactive rewarded advertising unit comprises one of an advertisement, a promotion, and an offer.

31. The method of claim 24, comprising:
mediating among a plurality of providers of the first interactive rewarded playable unit to determine which of a plurality of first interactive rewarded playable units is provided to the user within the virtual environment.

32. The method of claim 24, comprising:
mediating among a plurality of providers of the second interactive rewarded playable unit to determine which of a plurality of second interactive rewarded playable units is provided to the user within the first interactive rewarded playable unit.

33. The method of claim 24, comprising:
displaying a selection of a plurality of options to the user within the virtual environment,
wherein a first option comprises an offer to play the first interactive rewarded playable unit for measurable units, and wherein each of the remaining options comprises an offer to purchase a different amount of measurable units.

34. A system, comprising:
a server computer programmed to perform operations comprising:
enabling a user to interact within a virtual environment,
wherein the virtual environment comprises a plurality of measurable units configured to measure progress of the user within the virtual environment; and
one or more support provider computers programmed to perform operations comprising:
monitoring at least one characteristic of the user within the virtual environment;
detecting when the at least one characteristic of the user is below a predetermined threshold within the virtual environment, and, based thereon:
displaying a first interactive rewarded playable unit within at least a portion of the virtual environment,
wherein the user plays the first interactive rewarded playable unit to generate additional measurable units for use within the virtual environment by achieving a predetermined milestone in the first interactive rewarded playable unit;
activating the first interactive rewarded playable unit in response to a request by the user to engage in the first interactive rewarded playable unit;
displaying a second interactive rewarded playable unit within at least a portion of the first interactive rewarded playable unit at one or more intervals while the user engages in the first interactive rewarded playable unit; and
activating the second interactive rewarded playable unit in response to a request by the user to engage in the second interactive rewarded playable unit.

35. The system of claim 34, wherein the virtual environment comprises a main game.

36. The system of claim 34, wherein the first interactive rewarded playable unit comprises one of a fully-featured standalone game and a feature-limited demonstration of a fully-featured game.

37. The system of claim 36, wherein playing the first interactive rewarded playable unit incentivizes the user to download the fully-featured game for use as the virtual environment.

38. The system of claim 34, wherein the second interactive rewarded playable unit is displayed to the user when the user fails to achieve the predetermined milestone in the first interactive rewarded playable unit.

39. The system of claim 34, wherein the second interactive rewarded playable unit comprises one of an advertisement, a promotion, and an offer.

40. The system of claim 34, wherein the one or more support provider computers are programmed to perform operations comprising:
mediating among a plurality of support provider computers to determine which of a plurality of first interactive rewarded playable units is provided to the user within the virtual environment.

41. The system of claim 34, wherein the one or more support provider computers are programmed to perform operations comprising:
mediating among a plurality of support provider computers to determine which of a plurality of second interactive rewarded playable units is provided to the user within the first interactive rewarded playable unit.

42. The system of claim 34, wherein the one or more support provider computers are programmed to perform operations comprising:
displaying a selection of a plurality of options to the user within the virtual environment,
wherein a first option comprises an offer to play the first interactive rewarded playable unit for measurable units, and wherein each of the remaining options comprises an offer to purchase a different amount of measurable units.

43. An article, comprising:
a non-transitory computer-readable medium having instructions stored thereon that, when executed by one or more computers, cause the computers to perform operations comprising:
enabling a user to interact within a virtual environment,
wherein the virtual environment comprises a plurality of measurable units configured to measure progress of the user within the virtual environment;
monitoring at least one characteristic of the user within the virtual environment;
detecting when the at least one characteristic of the user is below a predetermined threshold within the virtual environment, and, based thereon:
displaying a first interactive rewarded playable unit within at least a portion of the virtual environment,
wherein the user plays the first interactive rewarded playable unit to generate additional measurable units for use within the virtual environment by achieving a predetermined milestone in the first interactive rewarded playable unit;
activating the first interactive rewarded playable unit in response to a request by the user to engage in the first interactive rewarded playable unit;
displaying a second interactive rewarded playable unit within at least a portion of the first interactive rewarded playable unit at one or more intervals while the user engages in the first interactive rewarded playable unit; and
activating the second interactive rewarded playable unit in response to a request by the user to engage in the second interactive rewarded playable unit.
